(19) United States
(12) Patent Application Publication
(10) Pub. No.: US 2013/0303608 A1
(43) Pub. Date: Nov. 14, 2013

(54) STABLE AQUEOUS SUSPENSIONS OF DBNPA, THEIR PREPARATION AND USES THEREOF AS BIOCIDES

(71) Applicants: Evgeny Shapiro, Haifa (IL); David Feldman, Haifa (IL); Rimma Khodakovskaya, Haifa (IL)

(72) Inventors: Evgeny Shapiro, Haifa (IL); David Feldman, Haifa (IL); Rimma Khodakovskaya, Haifa (IL)

(73) Assignee: BROMINE COMPOUNDS LTD., Be'er-Sheva (IL)

(21) Appl. No.: 13/884,726

(22) PCT Filed: Nov. 15, 2011
(86) PCT No.: PCT/IL2011/000877

§ 371 Date: Jul. 30, 2013

Related U.S. Application Data
(60) Provisional application No. 61/413,490, filed on Nov. 15, 2010.

(51) Int. Cl. A01N 37/34; A01N 25/04

(52) U.S. Cl. CPC A01N 37/34; A01N 25/04
USPC 514/528

(57) ABSTRACT

The present invention discloses novel biocide composition comprising 2,2-dibromo-3-nitrilopropionamide (DBNPA) being in the form of a stable aqueous suspension. Further are disclosed the preparation of these compositions and their biocidal uses.

### FIELD OF INVENTION

The present invention relates to biocide compositions.

More specifically, the invention relates to biocide compositions of DBNPA, their disinfection properties and applications, and to a method for the production thereof.

### BACKGROUND OF THE INVENTION

2,2-Dibromo-3-nitrilopropionamide (DBNPA) is a broad-spectrum biocide for controlling the growth of bacteria, fungi, yeasts, cyanobacteria and algae. See, for example, U.S. Pat. Nos. 4,800,082 and 4,241,080.

The most common mode of application of DBNPA is as a liquid formulation. Since DBNPA has poor solubility in water, these formulations typically contain as a carrier a mixture of water and an organic solvent, most often a glycol (for example, polyethylene glycol (PEG), dipropylene glycol (DPG) and others). The concentration of the DBNPA in such liquid formulations is typically about 5-25%. Such liquid formulations of DBNPA are described in a series of patents, for example, U.S. Pat. Nos. 4,163,796 (2.5% DBNPA), 4,163,797 and 4,232,041 (5% DBNPA), DE 2,854,078 (5% DBNPA), U.S. Pat. No. 4,163,795 (10% DBNPA) and U.S. Pat. No. 3,689,660 (15-25% DBNPA).

The use of organic formulations, however, is undesirable due to cost ineffectiveness and environmental concerns (see, for example, U.S. Pat. No. 5,627,135).

Alternatively, DBNPA is formulated as solid compacted products, available as granules or tablets (see, for example, European Patent No. 1,322,600). Although this mode of application is direct, it requires a suitable feeding system which may complicate the application.

Another form of application of DBNPA, is as an aqueous suspension. Such suspensions are typically obtained with the aid of suspending agents. Since. DBNPA is stable in water only under acidic conditions, special suspending agents are required, which are stable at a pH below 5. For example, WO 2007/096885 discloses a 30-50% aqueous suspension of DBNPA having a pH in the range of 1 to 4, containing xantham gum as the proposed thixotropic suspending agent, which suggests a high viscosity for avoiding sedimentation in a static state, and a moderate viscosity when pumping the slurry. Brookfield yield value (BYV) is usually used for characterization of dispersion viscosity. Presently-available suspensions, which are based on organic gel-forming agents, have a BYV which is >400 dyn/cm². The high viscosity characterizing presently known stable DBNPA suspensions is an undesirable feature.

Thus, there is a long felt need to develop novel DBNPA suspensions that would combine:
Stability of the suspension, even during prolonged storage;
Controllable and workable viscosity, in particular a BYV that is lower than 400 dyn/cm², preferably lower than 300 dyn/cm²;
No organic gel-forming agents, thereby forming completely aqueous DBNPA suspensions.

### SUMMARY OF THE INVENTION

The present invention discloses novel biocide composition comprising 2,2-dibromo-3-nitrilopropionamide (DBNPA) being in the form of a stable aqueous suspension. Further are disclosed the preparation of these compositions and their biocidal uses.

According to one aspect of the invention, there is provided a biocide composition comprising 2,2-dibromo-3-nitrilopropionamide (DBNPA), one or more water-soluble inorganic halide salts, one or more inorganic dispersants, and one or more inorganic thickeners selected from water-soluble polyphosphates, wherein the composition is in the form of a stable aqueous suspension.

According to one preferred embodiment, the concentration of DBNPA ranges from about 5% to about 50% by weight. Preferably, the concentration of DBNPA ranges from about 20% to about 25% by weight.

According to another preferred embodiment, the one or more water-soluble inorganic halide salts contains an inorganic cation selected from alkali metals, alkaline earth metals, and ammonium.

According to a further preferred embodiment, the concentration of the halide salt ranges from 10% by weight to 40% by weight. Preferably, the concentration of the halide salt ranges from about 30% by weight to about 35% by weight.

According to a further preferred embodiment, the one or more inorganic dispersants is selected from the group consisting of colloidal silica, colloidal alumina, magnesium trisilicate (MTS) and mixtures thereof.

Preferably, the one or more inorganic dispersants contains colloidal silica in the form of cationic grade silica sol solution (CGS-sol).

According to yet a further preferred embodiment, the concentration of the cationic grade silica sol solution ranges from about 10% by weight to about 18% by weight.

According to a further preferred embodiment, the dry-base concentration of the cationic grade silica ranges from about 3% by weight to about 6% by weight.

According to a further preferred embodiment, the biocide composition described herein further comprises colloidal alumina and/or magnesium trisilicate. Preferably, the concentration of the colloidal alumina and/or magnesium trisilicate, ranges from about 0.1% by weight to about 2% by weight.

According to a further preferred embodiment, the one or more water-soluble polyphosphate is an alkali metal polyphosphate. Preferably, the alkali metal polyphosphate is sodium hexametaphosphate (SHMP).

According to yet a further preferred embodiment, the dry-base concentration of the one or more inorganic thickeners ranges from 0.1% to 2.2% by weight.

According to a further preferred embodiment, the weight ratio between the inorganic thickener and the cationic grade silica sol ranges from about 0.1 to about 0.22 weight/weight.

According to a further preferred embodiment, the composition consists of:
a) DBNPA;
b) a halide salt selected from one or more of KBr, NaBr, NaBr, NaCl, CaBr₂, CaCl₂;
c) cationic grade silica sol solution;
d) colloidal alumina or magnesium trisilicate;
e) sodium hexametaphosphate solution.

Preferably,
a) the concentration of the DBNPA ranges from 5% to 50% by weight;
b) the concentration of the halide salt ranges from 10% to 40% by weight;
c) the dry base concentration of the cationic grade silica sol solution ranges from 3% to 6% by weight;
d) the concentration of the colloidal alumina or the magnesium trisilicate ranges from 0.1% to 2% by weight;
e) the dry base concentration of the sodium hexametaphosphate solution ranges from 0.7% to 1.2% by weight;
f) the weight ratio between the sodium hexametaphosphate and the cationic grade silica sol ranges from about 0.1 to about 0.22 weight/weight.

According to a most preferred embodiment of the invention, the biocide composition described herein consists of:
a) DBNPA at a concentration of about 20% by weight;
b) NaBr at a concentration of about 35%;
c) Cationic grade silica sol solution at a dry base concentration of about 5% by weight;
b) Colloidal alumina at a concentration of about 0.5% by weight;
c) Sodium hexametaphosphate solution (SHMPS) at a dry base concentration of about 0.8% by weight.

According to a further preferred embodiment, the viscosity of the stable aqueous suspension is characterized by a Brookfield yield value (BYV) ranging from 150 to 250 dyn/cm².

According to a further preferred embodiment, the concentration of the DBNPA decreases by up to 5% by weight, after being kept for 2 weeks at 45-50° C.

According to a further preferred embodiment, after freezing the composition and warming it to room-temperature, the composition re-forms a stable suspension.

According to another aspect of the invention, there is provided a method of preparing biocide compositions described herein, the method comprising mixing the DBNPA, the one or more water-soluble inorganic halide salts, the one or more inorganic dispersants to obtain an unstable suspension of DBNPA in a concentrated solution of the inorganic halide salt, followed by the addition of the water-soluble polyphosphates to obtain a stable DBNPA suspension.

According to one preferred embodiment, the water-soluble polyphosphates are added in a solution form. Preferably, the polyphosphate solution further includes one or more water-soluble inorganic halide salts.

According to yet another aspect of the invention, there is provided a method of treating water, this method comprising adding to a water source a biocide composition comprising 2,2-dibromo-3-nitrilopropionamide (DBNPA), one or more water-soluble inorganic halide salts, one or more inorganic dispersants, and one or more inorganic thickeners selected from water-soluble polyphosphates, wherein the composition is in the form of a stable aqueous suspension.

According to a further aspect of the invention, there is provided a use of the biocide compositions described herein, as antifungal agents.

### DETAILED DESCRIPTION OF THE INVENTION

The inventors of the present invention have now successfully developed stable aqueous suspensions of 2,2-dibromo-3-nitrilopropionamide (DBNPA), having controlled and workable viscosities, being essentially free of organic components. The stable aqueous suspension comprises a combination of DBNPA, one or more water-soluble inorganic halide salts, one or more inorganic dispersants, and one or more inorganic thickeners. These suspensions serve as biocide compositions and have a variety of uses in the treatment of water.

In particular, it has been found that the treatment of unstable aqueous suspensions of DBNPA in concentrated solutions (e.g., brines) of bromide and/or chloride salts of ammonium, alkaline and alkaline-earth elements, and containing colloidal alumina and/or a sol of colloidal silica, with a suitable thickener, such as an aqueous solution of sodium hexamethaphosphate (SHMP), affords uniform gel-like stable suspensions with low to moderate viscosity, indicating no settling of the DBNPA over a long period of time.

Thus, according to one aspect of the present invention there is provided a biocide composition which comprises DBNPA, one or more water-soluble inorganic halide salts, one or more inorganic dispersants, and one or more inorganic thickeners.

According to some preferred embodiments of the invention, the one or more inorganic thickeners is selected from water-soluble polyphosphates.

Therefore, according to this preferred embodiment of the invention, there is provided a biocide composition comprising 2,2-dibromo-3-nitrilopropionamide (DBNPA), one or more water-soluble inorganic halide salts, one or more inorganic dispersants, and one or more inorganic thickeners selected from water-soluble polyphosphates, wherein the composition is in the form of a stable aqueous suspension.

DBNPA can be provided as a powder, as granules, as tablets or as compacted materials.

DBNPA is preferably added at a concentration ranging from about 5% to about 50%, preferably from about 20% to about 25%.

The one or more water-soluble halide salts contains an inorganic cation selected from alkali metals, alkaline earth metals, and ammonium.

The counter-ion of this cation in each of the one or more water-soluble halide salts, is an halide anion.

The term “halide” as used herein refers to bromide, chloride, fluoride and iodide anions, preferably a bromide and/or a chloride.

The term “alkali metals” as used herein refers to group I metals selected from the group consisting of lithium, sodium, potassium, rubidium, and cesium. Of such alkali metals, lithium, sodium, and potassium are preferred; lithium and potassium are more preferred.

The term “alkaline earth metals” as used herein refers to elements of Group 2A in the periodic table of the elements. Exemplary alkaline-earth metals include, but are not limited to, barium (Ba), beryllium (Be), magnesium (Mg), calcium (Ca), and strontium (Sr). Preferably, the alkaline earth metal is calcium.

Examples of inorganic salts according to preferred embodiments of the present invention include, but are not limited to, NaBr, LiBr, KBr, NaCl, CaCl₂, CaSr₂, NH₄Br, etc.

The amount of the halide salts in the composition is dictated by its maximum solubility in water, including the water present in any of the components of the suspension, such as the silica sols and/or the SHMP solution.

In general, the concentration of the one or more halide salt(s) in the composition of the invention is at least 10% by weight. Preferably, the concentration of the halide salt ranges from about 10% by weight to about 40% by weight. The use of a larger amount affords a supersaturated solution that may lead to crystallization of the salt and destroying of the suspension. A smaller amount makes the suspension unstable and may induce hydrolysis of the DBNPA. According to preferred embodiments of the present invention, the concentration of the halide salt is at least 20% by weight; further preferably, this concentration ranges from about 30% by weight to about 35% by weight.

In particular, the concentrated solution of the inorganic halide salt is either saturated or nearly saturated.

According to some preferred embodiments of the invention, the dispersants added to form the stable DBNPA suspensions of the present invention, include, but are not limited to, colloidal silica, colloidal alumina, magnesium trisilicate (MTS) and mixtures thereof.

Although dispersants can be used both as fine powders and as stable aqueous sols, the sol form is preferable.

As can be seen in the Examples which follow, stable aqueous suspensions of DBNPA have been prepared when the dispersant is a colloidal silica sol, or contains a colloidal silica sol in combination with other types of dispersants.

The term “sol”, as used herein, refers to a colloidal suspension of very small solid particles in a continuous liquid medium. Under the proper conditions, sols do not gel or settle even after several years of storage, and may contain up to about 50% silica and particle sizes up to 300 nm, although particles larger than about 70 nm settle slowly.

The term “gel” refers to a coherent, rigid, continuous three-dimensional network of particles of colloidal silica. Gels can be produced by the aggregation of colloidal silica particles to form a three dimensional gel microstructure.

It was also surprisingly found that the colloidal silica is preferably a cationic grade silica sol (CGS-sol, such as Ludox® CL). In particular, it has been observed that treatment of DBNPA suspensions composed from other studied silica sols (such as anionic grade Ludox® LS with a sodium counter ion, or anionic grade pH stable Ludox® HAS and Ludox® TMA) by aqueous SHMP solution, changes the morphology of the suspension but the prolonged stabilization effect induced by the thickener is particularly noticeable in the case where cationic grade silica sol is present in the composition.

It has been further found that especially stable DBNPA suspensions are formed using CGS-sol (such as Ludox® CL) with a chloride counter ion.

In another example, it has also been shown that CGS-sol exhibits high stability in the presence of bromide or/and chloride salts of alkaline and alkaline-earth elements. In contrast, other studied sols undergo flocculation in the presence of NaBr, to form static non-fluid gels which may make the preparation of DBNPA suspensions hardly possible because of extremely high viscosity preventing handling and pumping the formulation.

As noted above, the silica sol is preferably provided as an aqueous solution (for example as a 30% by weight solution). It should be noted that the concentration of the colloidal silica as part of the biocide compositions of the present invention can be specified either as the weight percent of the silica sol solution of the total weight of the composition, or as the weight percent of the silica particles (dry base) of the total weight of the composition.

Thus, the 30% cationic grade silica sol solution is provided at a concentration ranging from about 10% by weight to about 18% by weight. It was found that its application at lower concentrations (<10%) may lead to an unstable flocculated suspension, whereas at concentrations above 18% the viscosity of the suspension is increased, and care should be taken to avoid the formation of a static non-fluid gel. According to preferred embodiments of the present invention, the concentration of the 30% cationic grade silica sol solution ranges between 14-18% by weight.

Given that the silica sol solution used in the experiments below was a LUDOX® CL (namely 10-18%, more preferably 14-18%), corresponds to dry base concentrations of the silica in the range of 3-6% by weight, more preferably from about 4% to about 5.5% by weight of silica.

It has been found that the addition of a small amount of colloidal alumina (e.g., Disperal®) improves the uniformity of the formed suspension and prevents the formation of large floccules of gel.

Thus, in one preferred embodiment of the present invention, the suspension contains both cationic colloidal silica and an additional dispersant which acts as a homogenizing agent. It was found that the colloidal alumina and the magnesium trisilicate (MTS) can both act as homogenizers.

Preferably, the additional homogenizing dispersant, such as colloidal alumina, is added at a concentration ranging from 0.1% to 2% by weight. At lower quantities (<0.1%) the suspension may become less uniform and is accompanied by the formation of large lumps of gelatinous floccules. Larger amounts (>2%) increase the viscosity of the suspension up to the formation of a static gel. In addition, as shown in the Examples section further below, in the presence of large amounts of colloidal alumina, DBNPA partially decomposes to afford coloration of the compositions and a reduction of the DBNPA concentration.

More preferably, the concentration ranges from 0.3% to 0.6%. For example, it has been observed that in the presence of 0.5-0.6% colloidal alumina the DBNPA dispersions are more uniform.

The fourth component within the DBNPA stable suspensions is a thickening agent, also termed thickener or gelling agent.

Thickening agents are well known in the art. These are often high polymers which are soluble or swellable in water or aqueous medium. Suitable thickening agents according to the present invention are water-soluble polyphosphates thickeners.

Preferable water-soluble polyphosphates are alkali metal polyphosphates, such as sodium polyphosphates.

Representative examples of sodium polyphosphates include, but are not limited to sodium hexametaphosphate (SMHP), sodium polyphosphate, sodium tripolyphosphate, sodium pyrophosphate or their aqueous solutions.

According one preferred embodiment of the present invention, the alkali metal polyphosphate is sodium hexametaphosphate (SHMP).

It was found that the use of SHMP in the form of an aqueous solution is preferred over the use of solid SHMP. Advantageously, the addition of an aqueous solution of SHMP to an unstable suspension of DBNPA in brine and CGS-sol (such as Ludox®CL), induces gelling of the composition and results in the formation of a stable system.

Thus, it should be noted that the concentration of the polyphosphate thickener as part of the biocide compositions of the present invention can be specified either as the weight percent of the polyphosphate thickener solution of the total weight of the composition, or as the weight percent of the polyphosphate particles (dry base) of the total weight of the composition.

Preferably, the thickening agent is added at a dry base concentration ranging from 0.1% to 2.2% by weight. More preferably, it is added at a dry base concentration ranging from 0.6% to 1.2% by weight. These ranges of thickener concentrations correspond to about 0.3% to 7.5% by weight of a polyphosphate thickener solution containing 30% polyphosphate (as was used in the examples below), preferably from about 2% to about 4% by weight of this solution, as part of the total weight of the composition.

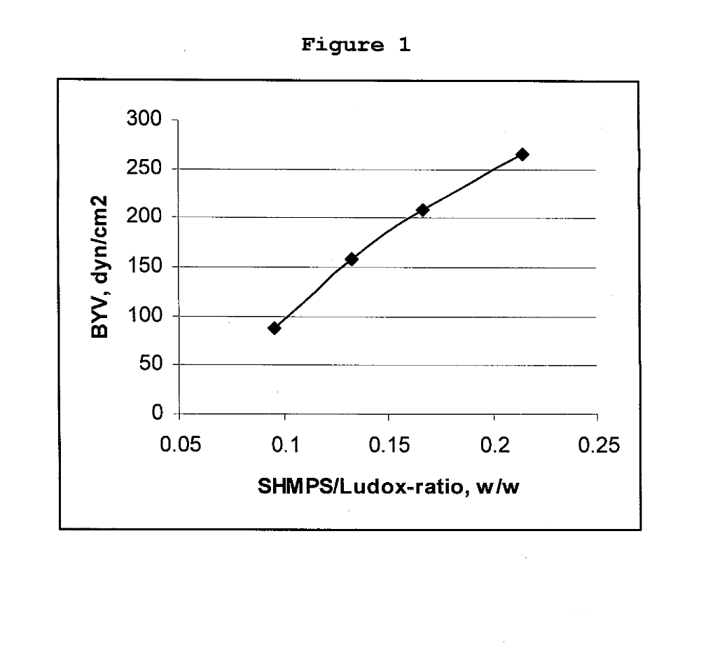

It further appears that the CGS-sol/thickener ratio determines the viscosity of the suspension. For instance, a 30% aqueous solution of SHMP (SHMPS), even in amounts of 9% based on the Ludox® CL, induces flocculation of the Ludox® CL. Complete gelling is observed at a ratio of ca. 25% to the Ludox® CL. The effect of the Ludox® CL/SHMPS ratio on the viscosity of the suspension is illustrated in FIG. 1, where the BYV is plotted vs. the SHMPS/Ludox® ratio.

The data show that a desired viscosity of the stable suspensions according to the present invention is retained within SMHPS/cationic grade silica sol ratio of 0.1-0.22 w/w.

As shown hereinbelow, the present inventors have successfully prepared the present DBNPA compositions to be in a stable, aqueous-suspension form.

The term “suspension” as used herein refers to a system in which small solid particles are essentially uniformly dispersed in a liquid medium.

The term “stable suspension”, as used herein describes a suspension that shows no separation after being stored for at least 1 week at ambient temperature.

Very often, the biocide compositions of the invention have been shown to be stable for longer periods of time, for example for at least 2 weeks at ambient temperature, and even for 1 month at ambient temperature.

Yet further, these novel DBNPA aqueous suspensions are characterized by high stability even after during prolonged storage at higher temperatures. For example, it has been shown that after being kept at 40-50° C. for two weeks, the DBNPA concentration either did not change at all, or decreased by no more than 5% by weight.

Thus, according to a preferred embodiment of the invention, the present compositions are characterized in that the concentration of the DBNPA therein decreases by up to 5% by weight, after being kept for 2 weeks at 45-50° C.

The stability of the present compositions was also demonstrated in freeze-thaw experiments, whereas, in contrast to many presently-known DBNPA suspensions, after freezing the composition and heating it back to ambient temperature, the composition re-formed as a stable suspension, and did not show any settling.

Thus, according to yet another preferred embodiment, the biocide compositions described herein are characterized in that after freezing the composition and warming it to room-temperature, the composition re-forms a stable suspension.

Furthermore, it has been advantageously found that the viscosity of these stable aqueous suspensions of DBNPA is controllable and can be low to moderate in value, quite in contrast to known aqueous suspensions of DBNPA whose stability is maintained at a cost of high viscosity. For example, while presently-known aqueous suspensions of DBNPA have a Brookfield yield value (BYV) of over 400 dyn/cm², the stable aqueous suspensions of DBNPA prepared according to the present invention have a controllable BYV which can be lower than 300 dyn/cm², and is often in the range of 150-250 dyn/cm², and can be as low as 80 dyn/cm², if so required.

Thus, according to another preferred embodiment of the invention, the biocide compositions described herein have a Brookfield yield value (BYV) which is lower than 300 dyn/cm². According to yet another preferred embodiment, the biocide compositions described herein have a Brookfield yield value (BYV) which ranges from 150 to 250 dyn/cm².

Finally, the present compositions are prepared without using any organic gel-forming agents, thereby forming completely aqueous DBNPA suspensions, this being an advantage in the industrial applicability of the preparation process of the DBNPA suspensions, and their use as biocides.

As can be seen in the examples which follow, the suspensions of the present invention can be made to have low to moderate viscosities, well-controlled by the amount of the inorganic thickener, and while not containing any organic products.

Some preferred embodiments of the present invention are described below.

According to one preferred embodiment of the present invention, there is provided a biocide composition consisting of:
a) DBNPA;
b) a halide salt selected from one or more of KBr, NaBr, NaBr, NaCl, CaBr₂, CaCl₂;
c) cationic grade silica sol solution;
d) colloidal alumina or magnesium trisilicate;
e) sodium hexametaphosphate solution.

A particularly preferred embodiment of the present invention, is such that the biocide composition consists of:
a) DBNPA at a concentration ranging from 5% to 50% by weight;
b) an halide salt selected from one or more of KBr, NaBr, NaBr, NaCl, CaBr₂, CaCl₂, at a concentration ranging from 10% to 40% by weight;
c) cationic grade silica sol solution, at a dry based concentration ranging from 3% to 6% by weight;
d) colloidal alumina or magnesium trisilicate, at a concentration ranging from 0.1% to 2% by weight;
e) sodium hexametaphosphate solution, at a dry based concentration ranging from about 0.1% to about 2.2% by weight;
f) the weight ratio between said sodium hexametaphosphate and said cationic grade silica sol ranges from about 0.1 to about 0.22 weight/weight.

In particular, a preferred composition of the present invention consists of:

(i) DBNPA at a concentration between 20% and 25% by weight;

(ii) One or more halide salt(s) at a total concentration between 30% and 35% by weight;

(iii) Cationic grade colloidal silica at a dry base concentration between 4% and 5% by weight;

(iv) Colloid (boehmite) alumina or magnesium trisilicate at a concentration between 0.3% and 0.6% by weight; and

(v) Sodium hexametaphosphate solution at a dry base concentration between 0.6% and 1.2% by weight.

Considering the desired viscosity being in the range of 150-250 dyn/cm² (BYV), it can be seen that the compositions prepared according to examples 1 and 3 are most preferable, having BLVs of 150 dyn/cm² and 208 dyn/cm², respectively.

Of these, an especially preferred composition is that prepared according to Example 4, namely a homogenized suspension containing 20.0% DBNPA, 34.3% NaBr, 15.0% Ludox® CL (solution, equal to 4.5% dry base), 0.5% Disperal® P2, and 2.5% SHMPS (equal to 0.75% dry base).

Thus, according to a preferred embodiment of the present invention, the composition consists of:

a) DBNPA at a concentration of about 20% by weight;

b) NaBr at a concentration of about 35%;

c) Cationic-grade silica sol solution at a dry-base concentration of about 5% by weight;

d) Colloidal alumina at a concentration of about 0.5% by weight;

e) Sodium hexametaphosphate solution (SHMPS) at a dry base concentration of about 0.8% by weight.

It is important to note that the compositions of the present invention can be formulated to control the obtained viscosity. Stable DBNPA aqueous suspensions were made having low viscosity (80 dyn/cm²), moderate viscosity (from 150 dyn/cm² and until 250 dyn/cm², such as in Examples 1, 3) or high viscosity (above 300 dyn/cm², such as in Example 5, or about 600 dyn/cm², as in Example 6).

The preferred compositions of the invention are prepared by combining DBNPA, one or more halide salts, colloidal silica, boehmite alumina (or a magnesium trisilicate) with water in a suitable vessel under stirring to form an unstable suspension, followed by the addition of the SHMP. As noted before, the SHMP is preferably added as an aqueous solution and is then termed SHMPS. Optionally, the SHMP solution also contains part of the halide salts dissolved in it.

Thus, in another aspect the present invention is a method of preparing the stable aqueous suspension biocide composition described herein, this method comprising mixing the DBNPA, the one or more water-soluble inorganic halide salts, and the one or more inorganic dispersants to produce an unstable suspension of DBNPA in a concentrated solution of an inorganic halide salt, followed by adding the water-soluble polyphosphates (thickener) to obtain the desired stable and uniform DBNPA suspension. This suspension also has a desired, workable viscosity as detailed hereinabove.

Table 1 summarizes the experimental data demonstrating the various modes of preparing the compositions of the present invention, in terms of mixing order and temperatures of reaction:

TABLE 1

| Experiment | | Temperature, |
|---|---|---|
| No. | Ingredients mixing order | ° C. |
| 1, 5 | Blending DBNPA, Disperal, NaBr | 25 |
| | and NaCl in mortar, | |
| | dissolving in water, | |
| | addition of Ludox, then SHMP | |
| | solution (SHMPS) | |
| 2 | Mixing DBNPA, NaBr and Disperal | 25 |
| | in water until dissolving NaBr | |
| | and Disperal, then Ludox, and | |
| | SHMPS | |
| 3 | Dissolving Disperal in aqueous | 40→25 |
| | NaBr solution, addition of a | |
| | solution of NaBr in Ludox, then | |
| | DBNPA, then a solution of NaBr in | |
| | SHMPS | |
| 4 | Mixing Ludox CL with a NaBr | 40→25 |
| | aqueous solution, then dissolving | |
| | Disperal, then addition of a | |
| | solution of NaBr in SHMPS | |
| 7 | Dissolving Disperal in a NaBr | 60→25 |
| | aqueous solution, then DBNPA, | |
| | followed by a NaBr solution in | |
| | Ludox, and finally a NaCl | |
| | solution in SHMPS | |

As can be seen from Table 1, the DBNPA, the halide salt(s), the colloidal silica and the boehmite alumina (or the magnesium trisilicate) may be added to the reaction vessel in any order.

For example, one preparation method comprises charging a reaction vessel with water, premixing two or more of the solid components to form a blend of solids, optionally grinding the resultant blend and adding the same, preferably in a portion wise manner under stirring, into the reaction vessel to form a suspension, feeding the aqueous colloidal silica sol solution into the reaction mixture and subsequently adding the aqueous solution of SHMP, thus allowing the formation of a stable, uniform, gel-like suspension.

Preferably, prior to the addition of the SHMP solution, the suspension is maintained under stirring for about 30-60 minutes at a temperature of 30-60° C. Following the addition of the SHMP solution, the composition is stirred for 0.5-2 hours, optionally under slight heating (−30-40° C.), to afford the stable gel-like suspension.

Another preparation method involves saturating, or nearly saturating, the components provided in an aqueous form (namely, the aqueous colloidal silica sol and/or the aqueous solution of SHMP) with halide salt(s) and subsequently feeding the same into the reaction vessel.

The preparation method is generally not controlled by pH and is defined by the pH value of colloidal silica solution (for example, for Ludox CL the pH value ranges between 3-5). Thus, the pH effect is only important when colloidal alumina is used as a thickener in the absence of colloidal silica. In that case, it should be adjusted by dilute HCl to <4 to induce the gelation.

As exemplified below, the aqueous suspension of DBNPA provided by the invention can be used as a biocide.

The term “biocide” as used herein refers to substance that kills microorganisms and their spores. Depending on the type of microorganism killed, a biocidal substance may be further defined as a bactericide (or antibacterial agent), a fungicide (or antifungal agent), algaecide (anti-algae agent) a yeasticide (anti-yeast agent) etc.

The term “antibacterial” means the action intended to limit, reduce or eliminate the bacteria present in an environment.

The term “antifungal” means the action intended to limit, reduce or eliminate the fungi (mycetes) present in an environment.

The term “anti-yeast” means the action intended to limit, reduce or eliminate yeast present in an environment.

The term “environment” means any medium comprising at least bacteria and/or fungi and/or yeast. The environment may be a liquid or a gas, and is preferably an aqueous liquid environment, more preferably a water source.

In particular, one field of application of the DBNPA biocide compositions of the present invention is in the treatment of water sources.

The water source to be treated includes but is not limited to cooling water, industrial water, waste water, water used in the paper industry, paint and sealant formulations and the like.

Thus, according to yet another aspect of the invention, there is provided a method of treating water, this method comprising adding to a water source, a biocide composition comprising 2,2-dibromo-3-nitrilopropionamide (DBNPA), one or more water-soluble inorganic halide salts, one or more inorganic dispersants, and one or more inorganic thickeners selected from water-soluble polyphosphates, wherein this composition is in the form of a stable aqueous suspension.

As shown in Table 5, the compositions of the present invention have shown excellent antifungal activity.

Therefore, according to yet another aspect of the invention, there is provided a use of the compositions described hereinabove, as antifungal agents.

### EXAMPLES

Materials and Analytical Methods

DBNPA, sodium bromide, and ammonium bromide were obtained from ICL Industrial Products.

Sodium chloride, CP grade, was obtained from Frutarom, batch 5553480.

Lithium bromide, 99+%, was obtained from Aldrich, Cat. No. 7550358.

Potassium bromide was obtained from Merck Art. 4905, lot 645K2741805.

Calcium bromide, hydrate, was obtained from Aldrich, Cat. No. 7681825.

Calcium chloride, anhydrous was obtained from Merck 1.02392.1000, lot F1540492841.

LUDOX® CL (colloidal silica), pH 3.8, suspension in water, containing 26% silica 4% alumina and approximately 1.2-1.4% Cl (the counter ion) was obtained from GRACE Davidson, lot 2009850631.

LUDOX® HSA (colloidal silica), pH 3.9, suspension in water, containing 29.7% silica was obtained from GRACE Davidson, lot 2009850903.

LUDOX® LS (colloidal silica), pH 8-9, suspension in water, containing 30% silica was obtained from Aldrich, Cat. No. 420808.

Disperal® P2 (high purity dispersible boehmite alumina system), containing 72% alumina, 0.002% Na₂O, 4% NO₃, particle size (d50 45 μm), was obtained from SASOL Germany GmbH, 538116, lot 11413.

Sodium hexametaphosphate as 30% aqueous solution (SHMPS) was obtained from RAMI Ceramics.

Magnesol®, grade D-sol, D60, was obtained from The Dallas Group of America, S.R.R#: 000-50-3.

The viscosity was measured using a “Brookfield spindle S04” Viscometer.

### Example 1

A homogenized suspension of 19.5% DBNPA, 31.3% NaBr, 1.5% NaCl, 15.1% Ludox® CL (solution, equal to 4.5% dry base), 0.6% Disperal® P2, and 2.4% SHMPS (equal to 0.7% dry base)

A mixture of DBNPA (93.40 g), Disperal® P2 (2.78 g), NaBr (145.01 g), and NaCl (7.00 g), was ground in a mortar to afford a uniform powder. A 0.5 L reactor, equipped with a mechanical stirrer was charged with water (128.05 g) and heated to 25° C. The mixture of solid ingredients was added to the water in portions, under stirring (−150 rpm) to afford a uniform suspension. Ludox® CL (77.81 g) was charged, and the mixture was stirred for 1 h at 25° C. SHMPS (12.44 g) was added and the mixture was finally stirred for 1 h at 25° C. to afford a uniform gel-like suspension with a specific gravity of 1.61 g/ml.

Rheological measurements showed that the suspension was a pseudoplastic liquid with a time-independent viscosity of around 350 cPa (at 60 rpm) and a Brook Yield Value (BYV) of around 150 dyn/cm² which displays decreasing viscosity with increasing shear rate (shear thinning fluid, STF).

The suspension was easily poured from the bottom outlet of the reactor to a 250 ml graduated cylinder. The suspension was stored for 2 weeks at ambient temperature with a no separation being observed.

Another sample of the suspension was stored for 2 weeks at 45-50° C. After storage, the DBNPA concentration was 19.0%, indicating no DBNPA decomposition.

A sample of the suspension was frozen at −35° C. After heating to ambient temperature, the initial suspension was recovered without any signs of settling or phase separation.

### Example 2

A homogenized suspension of 20.0% DBNPA, 36% NaBr, 15.0% Ludox® CL (solution, equal to 4.5% dry base), 0.6% Disperal® P2, and 2.4% SHMPS (equal to 0.7% dry base)

A 0.5 L reactor equipped with a mechanical stirrer was charged with water (111.17 g). DBNPA (92.36 g, particle size d50<0.3 mm), Disperal® P2 (2.80 g), and NaBr (166.09 g) were charged into the reactor, under stirring (−150 rpm) to afford a uniform suspension. Ludox® CL (76.70 g) was charged, and the mixture was stirred for 30 min at 25° C. SHMPS (12.44 g) was added. The mixture (˜350 ml) became more viscous and changed to a uniform gel-like dispersion. The mixture was stirred for 0.5 h at 25° C., 1 h at 40° C. and finally cooled to 25° C., to afford a uniform gel-like suspension with a specific gravity of 1.72 g/ml.

Rheological measurements showed that the suspension was a STF with a time-independent viscosity of around 877 cPa (at 60 rpm) and a Brook Yield Value (BYV) of 406 dyn/cm².

The suspension was easily poured from the bottom outlet of the reactor to a 250 ml graduated cylinder. The suspension was stored for 2 weeks at ambient temperature with no separation being observed.

Another sample of the suspension was stored for 2 weeks at 45-50° C. After storage, the DBNPA concentration was 20.5%, indicating no DBNPA decomposition.

A sample of the suspension was frozen at −35° C. After heating to ambient temperature, the initial suspension was recovered without any signs of settling or phase separation.

### Example 3

A homogenized suspension of 21.5% DBNPA, 29.2% NaBr, 16.0% Ludox® CL (solution, equal to 4.8% dry base), 0.54% Disperal® P2, and 3.4% SHMPS (equal to 1% dry base)

To a solution of NaBr (180.07 g) in water (246.83 g) heated to 40° C. was added Disperal P2 (4.503 g) under stirring, to afford a turbid sol. A saturated solution of NaBr (52.46 g) in Ludox® CL (134.22 g) was added. The mixture was stirred for 10 min and DBNPA (180.29 g) was added in portions. The mixture was stirred for 25 min at 40° C. to afford a turbid suspension and treated with a saturated solution of NaBr (12.94 g) in SHMPS (2.8.94 g). The mixture immediately became viscous but stirrable. The uniform suspension was cooled to 25° C. over 0.5 h, aged for 30 min under stirring, and easily poured from the bottom of the reactor and onto a 0.3 mm sieve to remove large pieces of solid material (total residue was 18.86 g).

The product was a uniform gel-like suspension (759.16 g) with a specific gravity of 1.72 g/ml. The yield was 90%.

Rheological measurements showed that the suspension was a STF with a BYV of 264 dyn/cm².

The suspension was stored for 2 weeks at ambient temperature with no separation being observed. After storage, the DBNPA concentrations (calculated on the base of Br-active concentration) in the upper, middle and lower ml portions of the suspension were 22.1, 22.1, and 22.7%, respectively, indicating no settling of the DBNPA.

Another sample of the suspension was stored for 2 weeks at 45-50° C. After storage, the DBNPA concentration was 20.5%, indicating no DBNPA decomposition.

A sample of the suspension was frozen at −35° C. After heating to ambient temperature, the initial suspension was recovered without any signs of settling or phase separation.

### Example 4

A homogenized suspension of 20.0% DBNPA, 34.3% NaBr, 15.0% Ludox® CL (solution, equal to 4.5% dry base), 0.5% Disperal® P2, and 2.5% SHMPS (equal to 0.75% dry base)

To a mixture of NaBr (300.93 g) and water (252.38 g) heated to 40° C. was added Ludox® CL (136.65 g). The mixture was stirred for 24 min until the NaBr completely dissolved, then Disperal® P2 (4.503 g) was added. The mixture was stirred for an additional 15 min to complete the colloidal alumina disintegration and DBNPA (182.05 g) was introduced into the reactor in portions, to obtain a turbid sol. The mixture was stirred for 1 h at 40° C. to afford a suspension, and treated with a saturated solution of NaBr (11.57 g) in SHMPS (22.83 g). The uniform, viscous suspension was cooled to 25° C. over 0.5 h, aged for 1 h under stirring, and easily poured from the bottom of the reactor to obtain a gel-like suspension (880.38 g) with a specific gravity of 1.66 g/ml. The yield was 97%.

Rheological measurements showed that the suspension was a STF with a BYV of 208 dyn/cm².

The suspension was stored for 2 weeks at ambient temperature with no separation being observed.

Another sample of the suspension was stored for 2 weeks at 45-50° C. After storage, the DBNPA concentration was 20.5%, indicating no DBNPA decomposition.

A sample of the suspension was frozen at −35° C. After heating to ambient temperature, the initial suspension was recovered without any signs of settling or phase separation.

### Example 5

A homogenized suspension of 20.1% milled DBNPA, 31.1% NaBr, 1.5% NaCl, 15.0% Ludox® CL (solution, equal to 4.5% dry base), 0.6% Disperal® P2, and 2.3% SHMPS (equal to 0.69% dry base)

A 0.5 L reactor equipped with a mechanical stirrer was charged with water (128.05 g), followed by portions of a fine powder blend of DBNPA (92.35 g, particle size d₅₀ 45 micron), Disperal® P2 (2.79 g), NaBr (145.06 g), and NaCl (1.51 g), under stirring (−150 rpm). The mixture was heated to 40° C. to afford a uniform suspension. Ludox® CL (77.79 g) was charged, and the mixture was stirred for 35 h at 40° C. SHMPS (12.07 g) was added and the mixture was stirred for 0.5 h at 40° C., cooled to 25° C. over 0.5 h, and finally stirred for 0.5 h. to afford a uniform gel-like suspension with a specific gravity of 1.67 g/ml. The rheology study showed that the suspension is a STF with a time-dependent viscosity of around 820 cPa (at 60 rpm) and, a Brook Yield Value (BYV) of around 376 dyn/cm².

The suspension was readily poured from the bottom outlet of the reactor to a 250 ml graduated cylinder. The suspension was stored for 2 weeks at ambient temperature with no separation being observed. After storage, the DBNPA concentrations in the upper and lower 50 ml portions of the suspension were 20.9 and 21.2%, respectively, indicating no settling of the DBNPA.

Another sample of the suspension was stored for 2 weeks at 45-50° C. After storage, the DBNPA concentration was 19.6%, indicating no DBNPA decomposition.

A sample of the suspension was frozen at −35° C. After heating to ambient temperature, the initial suspension was recovered without any signs of settling or phase separation.

### Example 6

A homogenized suspension of 20.1% milled DBNPA, 34.3% NaBr, 1.1% NaCl, 10.2% Ludox® CL (solution, equal to 3.06% dry base), 0.5% Disperal® P2, and 7.0% SHMPS (equal to 2.1% dry base)

A 0.5 L reactor equipped with a mechanical stirrer was charged with NaBr (127.92 g) and water (120.02 g). The mixture was heated to 60° C., under stirring at 200 rpm, until the NaBr had completely dissolved. Disperal® P2 (2.27 g) was charged and the mixture was stirred at 60° C. to afford a turbid sol. Undersized DBNPA (90.00 g) was charged and the mixture was cooled to 45-50° C. A saturated 36% solution of NaBr in Ludox® CL (71.13 g, prepared by dissolving NaBr in Ludox at 40° C. and cooling to 25° C.) was charged, under stirring. The mixture was stirred for 12 min and cooled to 40° C. A saturated 13.2% solution of NaCl in SHMPS (36.2 g, prepared by dissolving NaCl in SHMPS® at 40° C. and cooling to 25° C.) was charged, under stirring. The mixture was cooled to 25° C. over 30 min and stirred for 0.5 h, to afford 387.15 g of a uniform gel-like suspension with a specific gravity of 1.63 g/ml, which was easily poured from the reactor into a 250 ml cylinder. A rheology study showed that the suspension is STF with a time-independent viscosity of around 487 cPa (at 60 rpm) and a Brook Yield Value (BYV) of around 600 dyn/cm². The suspension was stored for 2 weeks at ambient temperature with no separation being observed.

### Example 7

A homogenized suspension of 20% DBNPA, 20% NaCl, 15% Ludox® CL (solution, equal to 4.5% dry base), 0.6% Disperal® P2, and 2.8% SHMPS (equal to 0.84% dry base)

A mixture of DBNPA (9.05 g), Disperal® P2-(0.276 g) and NaCl (9.0 g) was ground in a mortar to afford a uniform powder. The mixture of solid ingredients was added to water (18.25 g) in portions, under stirring, to thereby obtain a flocculated suspension. The suspension was stirred for 30 min at ambient temperature then Ludox® CL (7.59 g) was charged. The mixture was stirred for 15 min to afford a uniform suspension. SHMPS (1.25 g) was added and the mixture was finally stirred for 1 h to afford a′ uniform gel-like suspension with a specific gravity of 1.28 g/cm³. The suspension was easily poured into a 25 ml graduated cylinder. The suspension was stored for one week at ambient temperature with no separation or settling being observed.

### Example 8

A homogenized suspension of 20% DBNPA, 31% NH₄Br, 17% Ludox® CL (solution, equal to 5.1% dry base), 0.6% Disperal® P2, and 2.8% SHMPS (equal to 0.84% dry base)

A mixture of DBNPA (9.06 g), Disperal® P2 (0.277 g) and NH₄Br (14.03 g) was ground in a mortar to afford a uniform powder. The mixture of solid ingredients was added to water (12.98 g) in portions, under stirring, to thereby obtain a flocculated suspension. The suspension was stirred for 1 h at ambient temperature and Ludox® CL (7.64 g) was charged. The mixture was stirred for 15 min to afford a uniform suspension. SHMPS (1.27 g) was added and the mixture was finally stirred for 1.5 h to afford a uniform gel-like suspension with a specific gravity of 1.47 g/cm³. The suspension was easily poured into a 25 ml graduated cylinder. The suspension was stored for one week at ambient temperature with no separation or settling being observed.

### Example 9

A homogenized suspension of 20% DBNPA, 42% LiBr, 16% Ludox® CL (solution, equal to 4.8% dry base), 0.6% Disperal® P2, and 2.8% SHMPS (equal to 0.84% dry base)

A mixture of DBNPA (9.07 g), Disperal® P2 (0.270 g) and LiBr (14.03 g) was ground in a mortar to afford a uniform powder. The mixture of solid ingredients was added to water (7.93 g) in portions, under stirring, to thereby obtain a flocculated suspension. The suspension was stirred for 15 min at ambient temperature and Ludox® CL (7.54 g) was charged. The mixture was stirred for 5 Min to afford a uniform suspension. SHMPS (1.24 g) was added and the mixture was finally stirred for 1.5 h to afford a uniform gel-like suspension with a specific gravity of 1.35 g/cm³. The suspension was easily poured into a 25 ml graduated cylinder. The suspension was stored for one week at ambient temperature with no separation or settling being observed.

### Example 10

A homogenized suspension of 20% DBNPA, 25% KBr, 17% Ludox® CL (solution, equal to 5.1% dry base), 0.6% Disperal® P2, and 2.8% SHMPS (equal to 0.84% dry base)

A mixture of DBNPA (9.01 g), Disperal® P2 (0.277 g) and KBr (15.62 g) was ground in a mortar to afford a uniform powder. The mixture of solid ingredients was added to water (15.62 g) in portions, under stirring, to thereby obtain a flocculated suspension. The suspension was stirred for 35 min at ambient temperature and Ludox® CL (7.61 g) was charged. The mixture was stirred for 5 min to afford a uniform suspension. SHMPS (1.27 g) was added and the mixture was finally stirred for 1 h to afford a uniform gel-like suspension with a specific gravity of 1.42 g/cm³. The suspension was easily poured into a 25 ml graduated cylinder. The suspension was stored for one week at ambient temperature with no separation or settling being observed.

### Example 11

### A homogenized suspension of 20.2% DBNPA, 27.5% CaCl₂, 16.7% Ludox® CL (solution, equal to 5.01% dry base), 0.6% Disperal® P2, and 2.6% SHMPS (equal to 0.78% dry base)

A mixture of DBNPA (10.02 g) and Disperal® P2 (0.277 g) was ground in a mortar to afford a uniform powder. The mixture of solid ingredients was added to an aqueous 45.9% solution of CaCl₂ (29.75 g) in portions, under stirring, to thereby obtain a flocculated suspension. Ludox® CL (8.31 g) was charged. The mixture was stirred for 10 min to afford a uniform suspension. SHMPS (1.30 g) was added and the mixture was finally stirred for 1 h to afford a flocculated gel-like suspension with a specific gravity of 1.4 g/cm³. The suspension was easily poured into a 25 ml graduated cylinder. The suspension was stored for one week at ambient temperature with no separation or settling being observed.

### Example 12

A homogenized suspension of 20% DBNPA, 30% NaBr, 1% NaCl, 15% Ludox® CL (solution, equal to 4.5% dry base), 0.6% Disperal® P2, and 2.3% SHMPS (equal to 0.69% dry base)

A mixture of DBNPA (18.5 g), Disperal® P2 (0.56 g), NaBr (28.2 g) and NaCl (1.03 g) was ground in a mortar to afford a uniform powder. The mixture of solid ingredients was added to water (28.22 g) in portions, under stirring, to thereby obtain a flocculated suspension. The suspension was stirred for 30 min at ambient temperature and Ludox® CL (15.41 g) was charged. The mixture was stirred for 15 min to afford a uniform suspension. SHMPS (2.47 g) was added and the mixture was finally stirred for 1 h to afford a uniform gel-like suspension with a specific gravity of 1.52 g/cm³. The suspension was easily poured into a 25 ml graduated cylinder. The suspension was stored for one week at ambient temperature with no separation or settling being observed.

### Example 13

A homogenized suspension of. 20% DBNPA, 29.7% CaBr₂, 16.7% Ludox® CL (solution, equal to 5.01% dry base), 0.6% Disperal® P2, and 2.6% SHMPS (equal to 0.78% dry base)

A mixture of DBNPA (11.5 g) and Disperal® P2 (0.349 g) was ground in a mortar to afford a uniform powder. The mixture of solid ingredients was added to an aqueous 50% solution of CaBr₂ (34.16 g) in portions, under stirring, to thereby obtain a flocculated suspension. Ludox® CL (9.62 g) was charged. The mixture was stirred for 8 min and SHMPS (1.56 g) was added. The mixture was finally stirred for 1 h to afford a uniform gel-like suspension with a specific gravity of 1.57 g/cm³. The suspension was easily poured into a 25 ml graduated cylinder. The suspension was stored for one week at ambient temperature with no separation or settling being observed.

### Example 14

A homogenized suspension of 20% DBNPA, 29% NaBr, 15% Ludox® CL (solution, equal to 4.5% dry base), 1% Magnesol, and 2.7% SHMPS (equal to 0.81% dry base)

A mixture of DBNPA (9.07 g), Magnesol (0.454 g) and NaBr (13.15 g) was ground in a mortar to afford a uniform powder. The mixture of solid ingredients was added to water (13.96 g) in portions, under stirring, to thereby obtain a flocculated suspension. The suspension was stirred for 50 min at ambient temperature and Ludox® CL (9.07 g) was charged. The mixture was stirred for 30 min to afford a uniform suspension. SHMPS (1.22 g) was added and the mixture was finally stirred for 1.5 h to afford a uniform gel-like suspension with a specific gravity of 1.53 g/cm³. The suspension was easily poured into a 25 ml graduated cylinder. The suspension was stored for one week at ambient temperature with no separation or settling being observed.

### Example 15

A homogenized suspension of 5.0% DBNPA, 41.1% NaBr, 11.0% Ludox® CL (solution, equal to 3.3% dry base), and 2.5% SHMPS (equal to 0.75% dry base)

To a mixture of NaBr (410.00 g) and water (405.32 g) heated to 40° C. was added Ludox® CL (110.01 g). The mixture was stirred for 5 min until the NaBr completely dissolved, then DBNPA (50.01 g) was introduced into the reactor in portions, to obtain a turbid sol. The mixture was stirred for 1 h at 40° C. to afford a suspension, and treated with a a SHMPS (24.98 g). The uniform, viscous suspension was cooled to 25° C. over 0.5 h, aged for 1 h under stirring, and easily poured from the bottom of the reactor to obtain a gel-like suspension (984.03 g) with a specific gravity of 1.54 g/ml. The yield was 98%.

Rheological measurements showed that the suspension was a STF with a BYV of 50 dyn/cm2.

The suspension was stored for 2 weeks at ambient temperature with no separation being observed.

### Example 16 (Comparative Example)

A homogenized suspension of 18.5% DBNPA, 18.5% NaBr, and 18.9% Ludox® CL (solution, equal to 5.67% dry base) (without SHMP)

A mixture of DBNPA (2.01 g) and NaBr (2.01 g) was treated with Ludox® CL (6.82 g), under stirring, to obtain uniform viscous gel-like slurry which changed into a static non-flowing gel after overnight storage.

This run demonstrates the unfeasibility of the application of Ludox® CL alone as a thickener for the stabilization of a DBNPA suspension.

### Example 17 (Comparative Example)

A homogenized suspension of 15.8% DBNPA, 16% NaBr, and 4.8% Disperal®(without SHMP and without Ludox)

A mixture of DBNPA (2.00 g), Disperal® (0.606 g) and NaBr (2.015 g) was ground in a mortar to afford a uniform powder. The mixture of solid ingredients was added to water (7.965 g) in portions, under stirring, to obtain a flocculated suspension. The suspension was treated by 10% HCl g) to adjust to pH 4, stirred for 1.5 h. to afford a uniform gel-like suspension of a sour cream consistency. The suspension was stored for one week at ambient temperature with no separation or settling being observed. However, storage of the suspension at 45-50° C. for 1 week induced a strong colorization as a result of the decomposition of DBNPA.

This run demonstrates the unfeasibility of using Disperal® alone as a thickener. The negative effect of Disperal® was also demonstrated in the next run.

A mixture of DBNPA (2.08 g) and Disperal® (2.02 g) was ground in a mortar to afford a uniform powder. The mixture of solid ingredients was added to water (6,109 g) in portions, under stirring, to obtain a static gel which was strongly colorized after overnight storage at room temperature.

The effect of using colloidal alumina on its own (without colloidal silica on the stability of DBNPA suspensions was also demonstrated in the following runs:

TABLE 2

| | DBNPA, | | | |
|---|---|---|---|---|
| Run | % | NaBr, % | Disperal ® | Comments |
| 40349-5336-20-2 | 20.35 | 0.00 | 19.82 | Static gel at pH |
| | | | | 3, colorization |
| | | | | and strong odor |
| | | | | in 16 h |
| 40349-5336-26-2 | 15.83 | 15.95 | 4.80 | Uniform gel - |
| | | | | like sour cream |
| | | | | at pH < 4, |
| | | | | colorization at |
| | | | | 50° C. |

Data of Table 2 demonstrates ability of colloidal alumina (Disperal®) affords gels at pH<4. Furthermore, in some cases undesired coloration was observed.

### Example 18 (Comparative Example)

Effect of the halide salt on the stability of DBNPA suspensions

A series of slurries of DBNPA (2.33 g) in water (7.3-7.65 g) was treated with Ludox® CL (1.61 g), followed by SHMPS (0.08-0.42 g), under stirring. The gel-like suspensions thereby obtained were unstable and underwent phase separation within several minutes.

The same procedure was repeated for DBNPA slurries (2.33 g DBNPA and 6.8-8 g water) with a constant amount of SHMPS (0.13 g) and various amounts of Ludox® CL (1.2-2.5 g). Again, the gel-like flocculated suspensions thereby obtained were unstable and underwent phase separation within several minutes to several hours.

This run demonstrates the importance of the inorganic salt in the composition.

### Example 19 (Comparative Example)

Effect of the colloidal silica (Ludox) form on the stability of DBNPA suspensions:

TABLE 3

| | | | Dispersant¹ | | | | |
|---|---|---|---|---|---|---|---|
| | DBNPA, | NaBr, | MTS | Lud | Lud, | Dis, | |
| Run | % | % | % | grade | % | % | Comments |
| 40349-5336-32-3 | 18.52 | 18.55 | 0.00 | CL | 55.65 | 0.00 | Uniform |
| | | | | | | | static gel |
| | | | | | | | stable at |
| | | | | | | | 20-50° C. for |
| | | | | | | | 1 month |
| 40349-5418 | 19.87 | 37.06 | 0.00 | HSA | 10.48 | 0 | Unstable |
| | | | | | | | suspension, |
| | | | | | | | settling |
| 40349-5336-20-2 | 20.35 | 0.00 | 0.00 | — | 0.00 | 19.82 | Colored |
| | | | | | | | static gel, |
| | | | | | | | odor! |
| 40349-5336-26-2 | 15.83 | 15.95 | 0.00 | — | 0.00 | 4.80 | Uniform gel- |
| | | | | | | | like sour |
| | | | | | | | cream, |
| | | | | | | | colorization |
| | | | | | | | at 50° C. |
| 39301-5246-4 | 29.22 | 29.21 | 3.69 | CL | 7.65 | 0.00 | Stable |
| | | | | | | | uniform at |
| | | | | | | | 20° C., phase |
| | | | | | | | separation + |
| | | | | | | | color at |
| | | | | | | | 50° C. |

Notes.
DDD-DBNPA-doped dispersion, MTS-magnesium trisilicate, Lud-Ludox ®, Dis-Disperal ®

TABLE 4

| | SHMPS/Ludox | |
|---|---|---|
| Ludox type | ratio,¹ w/w | Effect |
| CL | 0.0387 | Flocculation |
| | 0.049 | Flocculation |
| | 0.0893 | Immediate and complete gelling |
| LS | 0.2500 | Static gel in several hours (overnight) |
| HSA | 0.1555 | Static gel in several hours (overnight) |
| TMA | 0.1634 | Static gel in several hours (overnight) |

Note.
SHMP from ThermPhos was used

As seen in Table 3 and 4, all the colloidal materials tested, such as silica, alumina and even magnesium trisilicate may act as dispersants. The problem is the dispersions are not stable in all cases and quickly transform to static gels or undergo decomposition at elevated temperatures, excluding silica with positively charged surface with the combination with SHMP.

### Example 20

### Bio-Test Data

Samples of some of the prepared compositions were dispersed in hot (−45° C.) agar, under stirring. The amount of the biocide composition was calculated based on total biocide concentrations of 1000 ppm. The hot liquid suspension was poured into a Petri dish and cooled, to afford a solid agar gel containing the composition being tested. The central part of the solid agar (ID 1 cm) was replaced with the same size of agar containing mold, A. niger. The dishes were incubated for 3 days and the diameter of the fungal growth ring was measured.

All the results were carried out in triplicate to assure accuracy. The data on the inhibition of the growth of A. nigers are summarized in Table 5.

TABLE 5

| | | A. Niger |
|---|---|---|
| | | diameters |
| Sample | Description | (cm) |
| | No biocide | 8, 7.5, 7.2 |
| | (control) | |
| 7 | NH₄Br (31.0) | 5.5, 6, 5.8 |
| 8 | LiBr (42.1) | 4.6, 5.6, 5 |
| 9 | KBr (25.1) | 5, 5, 4.9 |
| 12 | CaBr₂ (29.7) | 5, 5, 4 |
| 11 | NaBr (29.9) + | 5.5, 5.5, 4 |
| | NaCl (1.1) | |
| 13 | NaBr(28.9) + MTS | 5, 5.5, 5 |

The data of Table 5 demonstrate the anti-fungal activity of the compositions against A. niger.

1. A biocide composition comprising 2,2-dibromo-3-nitrilopropionamide (DBNPA), one or more water-soluble inorganic halide salts, one or more inorganic dispersants, and one or more inorganic thickeners selected from water-soluble polyphosphates, wherein said composition is in the form of a stable aqueous suspension.

2. The biocide composition according to claim 1, wherein the concentration of DBNPA ranges from about 5% to about 50% by weight.

3. The biocide composition according to claim 2, wherein the concentration of DBNPA ranges from about 20% to about 25% by weight.

4. The biocide composition according to claim 1, wherein the one or more water-soluble inorganic halide salts contains an inorganic cation selected from alkali metals, alkaline earth metals, and ammonium.

5. The biocide composition according to claim 1, wherein the concentration of said halide salt ranges from 10% by weight to 40% by weight.

6. The biocide composition according to claim 5, wherein the concentration of said halide salt ranges from about 30% by weight to about 35% by weight.

7. The biocide composition of claim 1, wherein the one or more inorganic dispersants is selected from the group consisting of colloidal silica, colloidal alumina, magnesium trisilicate (MTS) and mixtures thereof.

8. The biocide composition according to claim 7, wherein the one or more inorganic dispersants contains colloidal silica in the form of cationic grade silica sol {CGS-sol} solution.

9. The biocide composition according to claim 8, wherein the concentration of said cationic grade silica sol solution ranges from about 10% by weight to about 18% by weight.

10. The biocide composition according to claim 8, wherein the dry-base concentration of said cationic grade silica ranges from about 3% by weight to about 6% by weight.

11. The biocide composition according to claim 9, further comprising colloidal alumina and/or magnesium trisilicate.

12. The biocide composition according to claim 11, wherein the concentration of said colloidal alumina and/or magnesium trisilicate, ranges from about 0.1% by weight to about 2% by weight.

13. The biocide composition according to claim 1, wherein said one or more water-soluble polyphosphate is an alkali metal polyphosphate.

14. The biocide composition according to claim 13, wherein said alkali metal polyphosphate is sodium hexametaphosphate (SHMP).

15. The biocide composition according to claim 1, wherein the dry-base concentration of said one or more inorganic thickeners ranges from 0.1% to 2.2% by weight.

16. The biocide composition according to claim 10, wherein the weight ratio between said inorganic thickener and said cationic grade silica sol ranges from about 0.1 to about 0.22 weight/weight.

17. The biocide composition according to claim 1, said composition consisting of:
a) DBNPA;
b) a halide salt selected from one or more of KBr, NaBr, NaBr, NaCl, CaBr₂, CaCl₂;
c) cationic grade silica sol solution;
d) colloidal alumina or magnesium trisilicate; e) sodium hexametaphosphate solution.

18. The biocide composition of claim 1, said composition consisting of:
a) DBNPA at a concentration of about 20% by weight; b) NaBr at a concentration of about 35%;
c) Cationic grade silica sol solution at a dry-base concentration of about 5% by weight;
d) Colloidal alumina at a concentration of about 0.5% by weight;
e) Sodium hexametaphosphate solution (SHMPS) at a dry base concentration of about 0.8% by weight.

19. The biocide composition of claim 1, wherein said stable aqueous suspension has a Brook-field yield value (BYV) of viscosity ranging from 150 to 250 dyn/cm².

20. The biocide composition of claim 1, wherein the concentration of said DBNPA decreases by up to 5% by weight, after being kept for 2 weeks at 45-50° C.

21. The biocide composition of claim 1, wherein after freezing said composition and warming it to room-temperature, said composition re-forms a stable suspension.

22. A method of preparing the biocide compositions of claim 1, said method comprising mixing said DBNPA, said one or more water-soluble inorganic halide salts, said one or more inorganic dispersants to obtain an unstable suspension of DBNPA in a concentrated solution of said inorganic halide salt, followed by the addition of said water-soluble polyphosphates to obtain a stable DBNPA suspension.

23. The method of claim 22, wherein said water-soluble polyphosphates are added in a solution form.

24. The method of claim 23, wherein said polyphosphate solution further includes one or more water-soluble inorganic halide salts.

25. A method of treating water, this method comprising adding to a water source a biocide composition comprising 2,2-dibromo-3-nitrilopropionamide (DBNPA), one or more water-soluble inorganic halide salts, one or more inorganic dispersants, and one or more inorganic thickeners selected from water-soluble polyphosphates, wherein said composition is in the form of a stable aqueous suspension.

26. A use of the biocide compositions according to claim 1, as antifungal agents.
